(19) United States
(12) Patent Application Publication
(10) Pub. No.: US 2021/0315225 A1
(43) Pub. Date: Oct. 14, 2021

(54) PROCESS OF PRODUCTION OF VEGETABLE CHEESES WITHOUT ANIMAL INGREDIENTS

(71) Applicant: Sabina Baglio, Barrafranca (IT)

(72) Inventor: Sabina Baglio, Barrafranca (IT)

(21) Appl. No.: 17/058,986

(22) PCT Filed: Jun. 4, 2018
(86) PCT No.: PCT/IT2018/000080

§ 371 Date: Nov. 25, 2020

(51) Int. Cl. A23C 20/02; A23P 30/10

(52) U.S. Cl. CPC A23C 20/025; A23P 30/10

(57) ABSTRACT

A process for making vegetable cheeses without ingredients of animal origin includes the step of providing a predetermined quantity of starting vegetable material, and also includes the step of thickening the starting material by spontaneous fermentation or by induced fermentation by means of adding at least one fermentation promoter ingredient of vegetable origin.

### BACKGROUND OF THE INVENTION

Nowadays, the widespread knowledge of the effect of food on human health has resulted in a predilection for eating foods of vegetable origin and a reduction, or abandonment, of foods of animal origin. This is also recommended by the WHO (World Health Organization) guidelines for preventive purposes, and is implemented as preventive treatment in many cases of serious illness, such as cancer.

The market has developed accordingly by proposing a greater number of ready-to-serve vegetable-based foods than in the past. The industry in particular aims to propose vegetable-based foods corresponding to traditional animal-based foods so as to meet the now consolidated tastes of the consumers.

In following with this trend, there has been an ever-increasing number of vegetable cheeses created.

However, the Applicant detects that the vegetable cheeses currently offered by the market have several disadvantages.

One very important disadvantage is due to the fact that it has not been possible to make a vegetable cheese that can be compared in flavor and consistency with the traditional ones. In fact, today vegetable cheeses are seen by the end users as something very different from the traditional cheese made of animal milk. This limits the predilection of the public and does not allow accessing the market of those persons who are uncertain or traditional who continue buying cheeses of animal origin.

Another disadvantage is given by the fact that the current vegetable cheeses hardly achieve all the consistencies of traditional cheeses, whereby the offer is not diverse.

If it were possible to overcome the problem of the variety of the vegetable cheeses, important problems on global nutrition would accordingly also be resolved. As is indeed known, the increase of the population will cause the need in the future to reduce animal breeding, because it absorbs too many vegetable food resources that should be intended for man. Vegetable cheeses are an answer to this need, by transforming vegetables into convenience foods with a greater yield than the one obtained through breeding. There would be significant benefits also on an industrial level, because rather than being tied to milking rotations, the vegetables could be transformed into vegetable cheeses on a continuous cycle.

The Applicant notes that the cheese consistency of the current vegetable products is obtained with disadvantageous processes.

Traditionally, the consistency of cheeses—both animal and vegetable cheeses—is given by the thickening of a liquid base.

For animal cheeses, the thickening occurs by clotting during a step of cooking the milk.

The tofu, which is the most ancient vegetable cheese known, is thickened in the same manner, resulting in certain nutritional substances being lost during the heating.

Moreover, the tofu is notoriously a flavorless cheese.

Other cheeses—such as almond cheese—are formed using thickening substances such as coconut oil, forcing a mass of unhealthy saturated fats to be involved.

Often brewer's yeast flakes are used to correct the flavor of the vegetable cheeses and near it to the one of traditional cheeses. However, the flavor is not the same and it is acceptable for a vegan user but not for a traditionalist. Moreover, yeasts are not tolerated by everyone and may cause bloating in the user.

Various attempts to make vegetable cheeses emerge from patent literature, for example from:
D1—DE202007017700
D2—JP2009171877
D3—CN103549
D4—CN103082018
D5—CN101473872

However, these documents define and repeatedly confirm an apparent limitation of the field, and that is the one of not being able to make a 100% vegetable cheese. A technical prejudice towards the possibility of making 100% vegetable cheeses is confirmed, given that the market request is undergoing strong growth and several attempts have been made to indulge it up to very recently.

By analysing the documents mentioned, it in fact has emerged that they use probiotics of animal origin traditionally used in the dairy industry both to make cheese and with the goal of nearing the flavor of dairy products. The products resulting therefrom normally are sold with the “suitable for vegans” brand, but this is clearly a misleading approximation that buyers are not aware of.

In certain cases, the probiotics proposed by such documents originate from milk and its by-products, in others from intestine and feces, in others from human dermis. Such bacteria are also necessarily cultivated for mass industrial use, and the cultivation occurs in soil consisting of animal meat/dairy/red blood cells. In particular, we would like to point out the following.

D1—DE202007017700 is a German patent from 2009 which anticipates the general teaching of making a vegetable cheese using a liquid vegetable starting base and causing it to thicken by fermentation.

However, although D1 declares to want to make a wholly vegetable cheese—that is without animal substances (see for example, paragraph [0005])—it is worth noting that it is not capable of achieving this object. Indeed, it in general proposes to acidify by adding “carbohydrate-degrading microorganisms” for the thickening. D1 then continues by disclosing bacterium “Streptococcus thermophilis and/or Lactobacillus bulgaricus” (see for example, paragraph [0025] Example 1) as the only specific examples.

The two microorganisms mentioned are the classical microorganisms used in making cow's milk cheese and are of animal origin and not vegetable origin.

If this detail were made explicit on the labels, it would be a sufficient condition to divert the vegan public from purchasing the product.

D2—JP2009171877 is a Japanese patent from 2009 which proposes to make vegetable cheeses by fermentation of vegetable mass. Unlike D1, it proposes to use butryc acid bacteria for the fermentation. This is a milk acid, present also in vomit, and in this case too, it is a substance of animal origin.

D3—CN103549 is a Chinese patent from 2015 that describes making vegetable cheeses. However, the starting ingredients are a mixture of vegetables and animal foods, such “egg white and milk”. The fermentation agents used are bifidobacterium longum, bifidobacterium lactis, lactobacillus acidophilus, lactobacillus rhamnosus.

So they are not 100% vegetable cheeses, due both to the mass to be fermented and to the fermentation agents, which are of animal origin.

D4—CN103082018 is a Chinese patent from 2013 similar to D3, that is it proposes to make vegetable cheeses starting from a mixed base of vegetable and animal products; in particular it mixes almond milk and goat milk. Therefore, the same comment made in this respect for D3, is valid.

In addition to rennet, it uses bacteria of the cheese for thickening—streptococcus thermophillus or streptococcus cremoris—which are all ingredients of animal origin.

D5—CN101473872 is a Chinese patent from 2009 that describes making cheeses with the “partial” substitution of milk proteins with sesame proteins. In order to do this, it proposes to use “milk and sesame” and to use lactobacillus as fermentation factor. Moreover, it uses rennet. The teaching of D5 is therefore comparable to the one of the other documents.

Therefore, the need to resolve such problems remains in the sector.

### SUMMARY OF THE INVENTION

It is a general object of the present invention to wholly or partly overcome the problems of the known technique.

It is a further general object of the present invention to provide cheeses wholly of vegetable origin.

It is a preferred object of the present invention to provide a large variety of vegetable cheeses of multiple consistencies and flavors.

It is another preferred object of the present invention to allow making vegetable cheeses with a low content of, or no, saturated fats.

It is a further preferred object of the present invention to provide vegetable cheeses having acceptable flavor and consistency also to non-vegan users.

It is a further preferred object of the present invention to provide a process for making vegetable-based cheeses that is easy and affordable to implement on an industrial level.

### DETAILED DESCRIPTION OF THE INVENTION

The present invention relates to a production process of vegetable cheeses without ingredients of animal origin.

Without ingredients of animal origin also means without probiotics of animal origin.

The invention was studied while paying particular attention to making food products of thickened consistency that can be compared with the consistencies of traditional animal milk-based products with the same name, and it is for this reason that the word “cheese” is used. The adjective “vegetable” clarifies that vegetable-based products are involved, alternative to the traditional ones of animal origin.

According to a first general aspect thereof, the present invention relates to making vegetable cheeses without ingredients of animal origin, comprising the step of providing a predetermined quantity of starting vegetable material, characterized in that it comprises the step of thickening the starting material by spontaneous fermentation or by induced fermentation by means of adding at least one fermentation promoter ingredient of vegetable origin. The spontaneous fermentation provides a spontaneous growth of microorganisms. In induced fermentation, the growth is assisted by the inoculum of previously-cultivated microorganisms; here they are of vegetable origin and as explained below, they may be cultivated with said same process of spontaneous fermentation performed in a step preceding the inoculum of a part of the vegetable mass to be fermented to obtain the cheese.

The Applicant has discovered that the fermentation surprisingly has the effect of breaking up the carbohydrates into sugars, and of increasing the contents and quality of proteins and fats, thus promoting thickening.

The consistency of the starting material is selected based on the type of cheese to be obtained, whereby it may be liquid, creamy or pasty. The starting material will form the mass of the cheese. The fermentation preferably is kept up to a desired consistency, and that is gelatinous, pasty or solid. The mass thus fermented may possibly undergo other processes, for example to increase the consistency, such as resting, clotting, cooking, ripening.

Vegetable material means a vegetable or any product obtained using a vegetable and without ingredients of animal origin, the first among them being vegetable yogurt.

The Applicant has surprisingly discovered that the fermentation associated with said starting material is not only capable of replicating the aggregation, but also the flavor of traditional cheeses, thanks to the acidification resulting therefrom. The degree of acidity during the fermentation preferably is between 4 and 5 on the pH scale. The length of the fermentation affects both the flavor and the consistency: more delicate with fewer hours of fermentation, stronger with more hours. Advantageously, many types of probiotic ingredients may also be used, thus in turn increasing the number of types of cheeses that can be obtained.

The invention thus provides a versatile and practical tool for obtaining an enormous variety of vegetable cheeses.

According to certain preferred embodiments, the process comprises a hydration step of the vegetable material prior to the fermentation step, for example by soaking, up to reaching predetermined conditions and successive draining.

The hydration facilitates the successive dispersion of fats and proteins, especially if the starting material comprises seeds, of which the hydration promotes the cutting. Dispersion in turn facilitates a uniform fermentation for the thickening of the vegetable proteins, especially if of the spontaneous type. The hydration assists also in the splitting of the sugars, which in turn are the nutrients for the bacterial strains, both the ones that are created spontaneously and replicate, and any inoculated ones.

According to certain preferred embodiments, the starting material is rich in proteins and fats and has a balanced ratio of fibres that are naturally transformed into sugars during the fermentation. The optimal balance between the various contents is obtained with a starting material that has a weight percentage on the total weight:
proteins: from 15% to 30%
fats: from 45% to 58%
fibre: from 8% to 15%
carbohydrates: from 4% to 30%

According to certain preferred embodiments of the invention, the starting vegetable material is, or mainly comprises: legumes, dried fruit, oilseeds, or a mix thereof.

According to certain preferred embodiments of the invention, the process provides adding salt to the starting material prior to the fermentation.

In general, it is worth noting that after the fermentation, there is the need to ensure the food safety and non-perishability of the product by means of treatments such as for example, pasteurisation. It is worth noting to this end, that the harmful enzymes that develop in the animal dairy processes are very sensitive to heat and therefore one of the most effective common methods is the one of subjecting the products to high-temperature pasteurisation, above 85° C. Differently, since the food of the invention is a wholly vegetable one—that is without inocula of bacterial strains of animal origin—the degree of contamination is very low and the treatments may be gentler.

Also the degree of acidity highly affects the thermoresistance of the microorganisms, and by keeping the pH between 4 and 5, does not allow the development of the sporogenic organisms, thus helping to implement gentle treatments.

Pasteurisation is a thermal treatment adapted to destroy all the pathogenic forms; according to the invention, it is possible to implement a low-temperature pasteurisation, for example between 60° C. and 70° C., or rapid high-temperature pasteurisation, for example exceeding 85° C. for no more than 10 minutes, followed by quick cooling.

According to certain preferred embodiments of the invention, the spontaneous fermentation occurs by spontaneous fermentation of the prebiotics naturally present in the starting material.

It is preferable in general for the spontaneous fermentation to be triggered by putting the starting material in an environment with a temperature comprised between 20 and 24° C. and with a humidity between 40 and 60%.

In general, said fermentation promoter ingredient may be for example, a probiotic ingredient cultivated prior to said fermentation of said starting material, the process comprising the step of inoculating the probiotic ingredient in said starting material prior to the fermentation thereof (in minority quantity with respect to the starting material), where the probiotic ingredient is cultivated with at least one of the following processes:
the probiotic ingredient is cultivated by spontaneous fermentation of preferably previously-hydrated vegetable material,
The probiotic ingredient is isolated from the fermented starting material in a preceding iteration of the process according to any one of the preceding claims, for example the probiotic ingredient is serum generated during said preceding iteration of the process.

In other words, during the implementation of the process for making a cheese, a part of the fermented material to be used as probiotic is isolated during the successive repetition of the process to obtain another cheese. The advantages include the possibility of using a large variety of probiotic materials that affect the results, including flavor. This makes it easy to obtain a wide variety of cheeses.

Preferred probiotic ingredients include: vegetable-based whey starter culture, vegetable probiotic, vegetable yogurt. Hence, yogurt may be used both as starting material for the fermentation and as probiotic inoculum.

According to certain preferred embodiments, said fermentation occurs in the presence of light and/or in a closed and airtight environment.

The fermentation time is to allow the transformation of the starting material, whereby it preferably has a length comprised between 8 hours and 4 days and occurs in an environment kept at a temperature comprised between 20 and 24° C. with humidity between 40 and 60%. The fermentation is interrupted after such period, for example by increasing the temperature to carry out a pasteurisation and/or to form a curd cheese through the use of vegetable rennet, or by lowering the temperature to carry out a ripening.

In general, it is also preferable to interrupt the fermentation if the pH goes outside the range of 4 to 5.

According to certain preferred embodiments, the process comprises the step of making vegetable milk or vegetable yogurt with the starting material prior to the fermentation, and then using such milk and yogurt as starting material for the fermentation, where the yogurt is obtained by means of a preceding spontaneous or induced fermentation of the starting material by means of adding at least one fermentation promoter ingredient of vegetable origin, preferably salt is added to the milk and the yogurt prior to using them for a successive fermentation.

According to certain preferred embodiments of the invention, the process comprises the step of stopping the fermentation by lowering or raising the temperature.

In this case, after stopping the fermentation, the process preferably comprises the step of resting the mass agglomerated by fermentation at a temperature below the one of fermentation, preferably for a sufficient time to increase the consistency thereof.

According to certain preferred embodiments of the invention, the process obtains a processed vegetable cheese by means of the following steps:
using a starting material to be fermented, of creamy consistency comprising vegetable yogurt as main ingredient, or among the main ingredients, the starting material also comprises at least one vegetable oil and at least one fermentation promoter ingredient of vegetable origin;
fermenting the starting material up to a gelatinous consistency;
stopping the fermentation by means of heating, up to the melting, of the fermented starting material;
processing the melted mass to obtain the desired shape.

According to certain preferred embodiments of the invention, the process obtains a spreadable vegetable cheese by means of the following steps:
using a starting material to be fermented, of creamy consistency comprising pulsed seeds as main ingredient, or among the main ingredients, the starting material also comprises at least one fermentation promoter ingredient of vegetable origin;
fermenting the starting material up to a gelatinous, pasty or creamy consistency;
stopping the fermentation by means of lowering the temperature;
resting at a temperature below the fermentation temperature.

According to certain preferred embodiments of the invention, the process obtains a sliceable vegetable cheese by means of the following steps:
using a starting material to be fermented, of creamy consistency comprising pulsed seeds as main ingredient, or among the main ingredients, the starting material also comprises at least one fermentation promoter ingredient of vegetable origin;
fermenting the starting material up to a gelatinous, pasty or solid consistency;
stopping the fermentation by means of heating to a temperature above the fermentation one and below the melting one;
placing the fermented mass in a mold that allows the exit of the excess liquid;
resting the mass in mold at a temperature below the fermentation temperature.

According to certain preferred embodiments of the invention, the process obtains a hard vegetable cheese by means of the following steps:
using a starting material to be fermented, of pasty consistency comprising as main ingredient, or among the main ingredients, at least one among the following, or any mixture thereof: okara, pulsed seeds,
fermenting the starting material up to a solid consistency;
stopping the fermentation by means of raising or lowering the temperature;
resting the fermented mass at a temperature below the fermentation temperature.

According to certain preferred embodiments of the invention, the process comprises the step of using the fermented starting material to obtain a curd cheese with vegetable rennet and/or a cheese thickened with a vegetable thickener, for example carob flour.

Where mentioned, the whey starter culture is for example, the residual liquid of a preceding preparation of a vegetable cheese according to the present invention, or is for example, vegetable milk fermented for at least 2 days.

Examples of vegetable probiotics that can be used as inoculum include rejuvelac, wine, sauerkraut (typically fermented cabbage), fermented prunes.

The rejuvelac is a fermented enzyme beverage based on cereal such as wheat, quinoa, millet, oats, barley, rye, rice.

Preferably, if desired, the resting occurs at a temperature below the room temperature, for example maximum 12° C. In reality, the resting preferably is less than 10° C. to distinguish it from the ripening, which is generally between 10 and 12° C.

In general, also a steaming is possible, that is a step of staying in a humid environment at a temperature above the room temperature, which serves to drain the serum contained in a vegetable cheese put in the mold (for example, the characteristic cheese sieve).

When mentioned, vegetable milk means the known beverage obtained from vegetable extract, such as for example almond milk, rice milk, etc.

When mentioned, vegetable yogurt in general means a creamy product obtained from vegetable milk to which at least one prebiotic of vegetable origin was added that has the proprieties of helping the proliferation and development of the bacterial strains in a spontaneous manner and is caused to ferment in a time which is less than or equal to 10 hours. Preferably soya is avoided.

According to a general aspect thereof, the invention relates to a process for cultivating a probiotic ingredient wholly of vegetable origin, characterized by the step of providing a predetermined quantity of starting vegetable material and by the step of inducing a spontaneous fermentation of the prebiotics naturally present in the vegetable material up to obtaining the probiotic ingredient.

Preferably, the starting vegetable material is hydrated prior to the spontaneous fermentation.

Further features and advantages of the present invention will be more evident from the following detailed description of preferred embodiments thereof given by way of a non-limiting indicative example.

Hereinbelow, certain processes for making vegetable cheeses according to the present invention in particular are described.

### Example 1

### Ripened Cheese

### Appearance: PECORINO CHEESE TYPE

### Ingredients:

Okara, preferably almond okara
Vegetable yogurt
Vegetable probiotic (preferably REJUVLAC) or vegetable-based whey starter culture
Salt (preferably WHOLE)

### Process:

STEP 1: Make a basic product with a creamy consistency by blending together all ingredients indicated above. Put the basic product in a mold. Other optional ingredients may be added to the product in the mold, such as for example pistachios, preferably inoculated with whole nuts or cut in half when put in the mold.
STEP 2: Put the basic product in the mold to ferment in a humid environment at a temperature above or equal to 24° for 8 to 24 hours. In this step, the product takes on a solid consistency called a caciotta and develops an acidity that allows a flavor similar to pecorino cheese to be obtained.
STEP 3: Salting, by immersion in brine for a period ranging from 30 minutes to about one hour
STEP 4: Ripening, for 1 to 2 weeks at a temperature that is below the room temperature, for example less than or equal to 12° C. Ripening preferably occurs in a dark, ventilated place.
STEP 5: Generating mold (optional)

### Example 2

### Spreadable Cheese

Appearance: fresh ricotta

### Ingredients:

PEELED AND SOFTENED ALMONDS, for example for 12 HOURS
Vegetable YOGURT (preferably natural)
Whey starter culture
SALT
RENNET OF VEGETABLE ORIGIN

### Process:

STEP 1: Make a starting product having a smooth, full-bodied and creamy consistency by blending together all ingredients except the rennet.
STEP 2: Ferment the basic product to obtain a curd having gelatinous consistency; preferably the step lasts about 8 hours.
STEP 3: CLOTTING—Dissolve the rennet in hot water and combine the curd; bring the mixture to a boil, preferably for 3 to 4 minutes. Let rest heating for at least one hour. After it has rested, put the curd cheese in a cheese sieve (mold) to allow the excess liquid to be drained, preferably for at least 3 hours.

Now immediate consumption is possible or salted ricotta can be made by means of the following optional steps:
Step 4: PRESSING AND DRAINING—The ricotta (still in the cheese sieve) undergoes pressure to generate a further removal of liquid, preferably for a period of about 3 days. During this period, it is possible to turn over the cheese sieve one or several times a day to uniform the internal moisture of the product and avoid the formation of a crust on one side alone.
STEP 5: SALTING, preferably by immersion in brine, for example for about half an hour, or until it is dry based on the level of moisture of the vegetable cheese
STEP 6: RIPENING, at a temperature that is below the room temperature, for example less than or equal to 12° C. Ripening preferably occurs in a dark, ventilated place.

### Example 3

### Processed Cheese

Appearance: Burrata cheese with particular green colour due to the pumpkin seeds and olives, but it is also possible to make it in the delicate and white version without using the two ingredients, rather only almonds together with the rest of the ingredients. Ingredients:
ALMOND YOGURT
PUMPKIN SEEDS in vegetable milk
GREEN OLIVES in brine as source of probiotics
WATER
Self-made vegetable cream or ricotta, almonds and cashews
Vegetable-based WHEY STARTER CULTURE
HIGH-OLEIC COLD-PRESSED SUNFLOWER OIL
Vegetable rennet
Vegetable THICKENER, for example CAROB-SEED FLOUR (if necessary)
SALT, preferably whole

### Process:

STEP 1: Make a starting product having a creamy consistency by blending together all ingredients except the thickeners, the vegetable rennet and the cream, up to obtaining a smooth and shiny cream.
STEP 2: Fermentation to obtain a curd and for the acidification
STEP 3: Bring the thickened mixture with the vegetable cream or ricotta to a boil for about 3 minutes, lower the temperature and inoculate rennet and thickener up to obtaining a smooth and stringy mixture. Part of the mixture is processed by hand by stretching the cheese obtained, while the other part is made into small pieces.
STEP 3: Resting of the mixture in the mold up to obtaining a hard cheese, for example the resting period lasts 5 hours

### Example 4

### Processed Cheese

### Appearance: MOZZARELLA

### Ingredients:

ALMOND YOGURT
SEED MILK (optional)—Depending on the flavor and properties to be obtained, seed milk can be added, for example pumpkin or sesame seed milk.
COLD-PRESSED SUNFLOWER OIL
SALT, preferably WHOLE
Whey starter culture
Vegetable rennet
ICE-COLD WATER and/or brine (use after the stretching, not as an ingredient)

### Process:

STEP 1: Make a starting product for fermentation with a creamy consistency by blending together the yogurt, oil and salt up to obtaining a smooth and shiny full-bodied, voluminous mixture. The milk is fermented separately by inoculating the whey starter culture and bringing it to a temperature of about 40° C.
STEP 2: Fermentation, preferably for about 8 hours both for the mixture and for the milk to ensure the milk acidifies
STEP 3: CLOTTING—Bring the milk to a temperature of about 40° C. and add the starting product already fermenting, in addition to the rennet and whey starter culture. Let rest warm to favour clotting.

After curd cheese has formed with pieces having average size of about 5 to 7 mm, the curd cheese is cut.
STEP 4: STRETCHING—The cut curd cheese is collected and placed in hot water, preferably about 40°, where it is left to melt.

As soon as the mixture turns into melted cheese, it is stretched and formed. For example, the cheese obtained is stretched and mozzarellas or braids are formed which are immediately put into ice-cold water and/or brine.

The residual serum may be filtered and used as whey starter culture for other productions or as water for storing the cheese in.

### Example 5

### Semi-Hard or Hard Cheese

Appearance: Ripened cheese

### Ingredients:

SOFTENED (preferably for ONE NIGHT) CASHEWS AND ALMONDS
WHOLE SALT
REJUVLAC or WHEY STARTER CULTURE

### Process:

STEP 1: Make a starting material to be fermented having creamy consistency by blending together all the ingredients up to obtaining a smooth mixture.
STEP 2: FERMENTATION FOR 8 TO 36 HOURS BASED ON HOW PUNGENT the flavor is to be and how hard the cheese is to be.

It is possible to eat this cheese the way it is or after it has been refined by flavoring it or using it as a base to create other cheeses.

It can be stored in the fridge for about 2 weeks. It becomes more pungent if it is stored longer.

### Example 6

### Cheese By-Product from Another Cheese

### Appearance: PROCESSED CHESTAR

### Ingredients:

BASIC CHEESE from example 5 made with fermentation of about 12 HOURS
ALMOND YOGURT or PROBIOTIC
EXTRA VIRGIN OLIVE OIL or other vegetable oil, preferably unsaturated
WHITE WINE
VEGETABLE RENNET
SALT TO TASTE
CAROB-SEED FLOUR
TURMERIC TO TASTE FOR REFINING

### Process:

STEP 1: BLEND TOGETHER THE INGREDIENTS WITH A PINCH OF TURMERIC, EXCEPT THE VEGETABLE RENNET and carob flour. THE MIXTURE SHOULD BE CREAMY AND SMOOTH.
STEP 2: FERMENTATION—Fermentation occurs for about 8 hours.
STEP 3: PASTEURISATION AND CURD CHEESE—The mixture is pasteurised for example, by bringing it to a temperature of about 70°. This stops fermentation. This temperature preferably is kept for about 3 MINUTES. Vegetable thickener may be added, for example CAROB-SEED FLOUR. Let the temperature fall to about 40° and inoculate the vegetable rennet. Let the curd cheese form for about 30 minutes.

Cut the curd cheese.
STEP 4: COOKING—The CURD CHEESE is cooked AS SOON AS IT IS CUT IN ORDER TO MAKE IT ELASTIC AND FACILIATE THE AGGREGATION OF THE LUMPS.

Cooking preferably is done at a temperature between about 42° and 54°.
STEP 5: PLACEMENT IN MOLD—PUT IN MOLD and preferably SPRINKLE BOTH THE MOLD AND THE CHEESE WITH TURMERIC POWDER, LET COOL for example for about 3 HOURS and then let rest in the fridge for example, for ANOTHER 4 HOURS.

### Example 7

### Cheese By-Product from Another Cheese

### Appearance: Buffalo MOZZARELLA

### Ingredients:

Previous cheese made according to example 4
COLD-PRESSED SUNFLOWER OIL
Previous cheese made according to example 5 using fermentation of 20 hours
FERMENTED PRUNES as source of probiotics
SALT, preferably WHOLE
WATER

### Process:

STEP 1: Blend together all the ingredients and bring the mixture to a boil. It is sufficient to just bring it to a boil; work the mixture trying to stretch the stringy cheese obtained and stop heating immediately after. Pour the mixture into a mold or form a ball and quickly put it into cold water.

Putting it in a mold obtains a more consistent piece to be cut; putting it in cold water results in softer cheeses.

### Example 8

### Processed Cheese

Appearance: GREEN buffalo mozzarella

### Ingredients:

PUMPKIN-SEED MILK
NATURAL ALMOND VEGETABLE YOGURT
RICE OIL
Previous cheese made according to example 4 using fermentation of 12 hours
SALT, preferably whole
CAROB-SEED FLOUR

### Process:

STEP 1: BLEND TOGETHER ALL THE INGREDIENTS AND LET THE MIXTURE REST FOR 1 HOUR.
STEP 2: SET IN A CASSEROLE WHILE BRINGING THE MIXTURE TO ABOUT 40° C. UNTIL IT IS SMOOTH AND SHINY.
STEP 3: WORK THE CHEESE BY PULLING IT AND THEN POURING the mixture into a mold OR FORM A BALL or BRAID AND QUICKLY PUT IT IN COLD WATER.

### Example 8

### Ricotta Type Cheese

### Appearance: Ricotta

### Ingredients:

ALMONDS (all the parts of the seed, possibly excluding only the shells)
MACADAMIAS (all the parts of the seed, possibly excluding only the shells)
WATER
SALT

### Process:

STEP 1: Blend THE MACADAMIAS WITH WATER AND A PINCH OF SALT. THE MIXTURE SHOULD BE SMOOTH AND CREAMY/FROTHY AND RATHER SOFT.

BLEND THE ALMONDS (separately from the macadamias) WITH WATER AND A PINCH OF SALT. THE MIXTURE SHOULD BE SLIGHTLY GRANULAR AND ROUGH.

Make a starting product for fermentation with a creamy consistency by combining the two mixtures.

PUT IT IN A CHEESE SIEVE MOLD FOR DRAINING AND FERMENTATION.
STEP 2: FERMENTATION FROM 12 TO 24 HOURS

Pasteurisation or cooking and cardoon or fig inoculum of the rennet

Drain the whey starter culture serum at a temperature of about 12 to 14° C.
STEP 3: Immediate consumption or resting AT A LOWER “FRIDGE type” TEMPERATURE for AT LEAST 4 HOURS UP TO 6 HOURS, THEN salting and RIPENING IN ENVIRONMENT BETWEEN 10 TO 12° C. up to obtaining a cheese that can be grated

### Example 9

### Cheese By-Product from Another Cheese

Appearance: Creamy goat cheese

### Ingredients:

MACADAMIAS
CASHEWS
BASIC VEGETABLE CHEESE according to any one of the examples above
SALT
Vegetable-based WHEY STARTER CULTURE

### Process:

STEP 1: BLEND TOGETHER THE MACADAMIAS WITH THE WHEY STARTER CULTURE AND THE SALT AND LET FERMENT FOR 2 DAYS, obtaining a first fermented vegetable mixture.
STEP 2: BLEND TOGETHER THE CASHEWS WITH WATER AND LET FERMENT FOR 1 DAY, obtaining a second fermented vegetable mixture.
STEP 3: Make a cheese according to any one of the examples above.
STEP 4: Make a mixture comprising a weight percentage (on the total weight) of 10% of the first mixture and 70% of the second mixture and 20% of cheese from step 3. Add the salt.
Step 5: Combine and let rest in the fridge for about 8 hours.
STEP 6: Consumption or refinement, for example by adding LEMON PEELS, PEPPERCORNS, GARLIC, etc.

### Example 10

### Cheese By-Product from Another Cheese

### Appearance: Brie

ingredients:
CHEESE made according to any one of the examples above, FERMENTED FOR 12 TO 24 HOURS
RICE OIL HEATED SLIGHTLY TO 38°
SALT, preferably whole

### Process:

STEP 1: PUT ALL THE INGREDIENTS IN A MIXER AND BLEND UP TO OBTAINING A HOMOGENEOUS MIXTURE.
STEP 2: Resting and draining in molds
STEP 3: Flavoring is optional, for example with peppercorns and/or TRUFFLE OIL and/or AROMATIC HERBS.
STEP 4: Resting for 8 HOURS BEFORE EATING

### Example 11

### Cheese By-Product from Another Cheese (Ripened VLIE)

### Appearance: Ripened Brie

STEP 1: As for example 10, but after the ingredients are combined, let them ferment for about 10 hours.
STEP 2: Stop the fermentation with pasteurisation.

For example, it is possible to blend together the fermented mixture with the CAROB-SEED FLOUR AND SALT, and bring it to a boil, preferably FOR 3 MIN. WHILE CONTINOUSLY MIXING.

PUT THE MIXTURE IN A MOLD AND LET COOL DOWN, THEN PUT IT IN THE FRIDGE TO REST FOR AT LEAST 5 HOURS.
STEP 3: DIRECT SALTING—REMOVE THE CHEESE FROM THE MOLD USING DAMP HANDS SPRINKLED WITH SALT AND START MASSAGING THE CHEESE DELICATELY WHILE TRANSFERRING THE MOISTURE AND SALT TO IT.
STEP 4: RIPENING—IN A COOL PLACE AT A MAX. TEMPERATURE OF 12° C.—PLACE THE CHEESE ON GRIDS SO THE AIR CAN ALSO CIRCULATE FROM BELOW. RIPEN FOR ABOUT 48 HOURS OR MORE BASED ON THE TEMPERATURE.
IN ANY CASE, THE CHEESE WILL HAVE A THIN CRUST BUT WILL BE SOFT AND CREAMY ON THE INSIDE. PUT BACK IN THE FRIDGE AND LEAVE IT FOR ANOTHER 5 DAYS. IT IS POSSIBLE TO EAT IT IMMEDIATELY BUT FURTHER RESTING IN THE FRIDGE MAKES IT MORE COMPACT AND STRONGER AND GIVES IT A MORE DECIDED SMELL AND FLAVOR.

### Example 12

### Soft Cheese

### Appearance: FRESH CACIOTTA PRIMO SALE TYPE CHEESE

### Ingredients:

PUMPKIN SEEDS REHYDRATED FOR 2 TO 3 HOURS
VEGETABLE YOGURT
CAROB-SEED FLOUR or other vegetable thickener
EXTRA VIRGIN OLIVE OIL
DRY WHITE WINE AS FERMENTATION TRIGGER
SELF-MADE WHEY STARTER CULTURE OR REJUVLAC OR NATURAL vegetable PREBIOTICS
SALT

### Process:

STEP 1: Make a starting material for fermentation by blending together the PUMPKIN SEEDS WITH THE YOGURT, SALT, WINE and the probiotic.
STEP 2: LET FERMENT FOR 24 HOURS.
STEP 3: ONCE THE FERMENTATION TIME HAS TRANSPIRED, PUT THE MIXTURE BACK INTO THE MIXER AND ADD THE CAROB-SEED FLOUR BLEND UP TO OBTAINING A CREAMY MIXTURE.
STEP 4: PASTEURISATION—POUR EVERYTHING INTO A POT AND BRING TO A BOIL FOR 3 MIN. POUR THE MIXTURE INTO A CHEESE SIEVE IF IT IS TO REMAIN NATURAL OR
STEP 5: FLAVORING OPTIONAL
STEP 6: COOLING AND RESTING
STEP 7: Consumption after 5 to 8 hours of resting or ripening, after 10 hours of resting to become a consistency that can be grated.

### Example 13

### Cheese Made from Starting Material with Pasty Consistency

This recipe DOESN'T HAVE STARCHES and is EXCELLENT BOTH FRESH TO BE EATEN LIKE RICOTTA OR HARDENED WITH HEAT AND TIME.

### Ingredients:

PUMPKIN SEEDS (all the parts of the seed, possibly excluding the shells)
YOGURT used as WHEY STARTER CULTURE and not as main ingredient by quantity. WATER TO TASTE, IF NECESSARY
SALT

### Process:

STEP 1: Make a basic material for fermentation having pasty consistency by blending together all ingredients.
STEP 2: FERMENTATION for about 24 HOURS
STEP 3: PASTEURISATION

POUR THE MIXTURE INTO A SAUCEPAN AND BRING IT TO A BOIL FOR 3 MIN. TURN OFF AND POUR INTO THE CHEESE SIEVE. LET THE MIXTURE DRAIN A FIRST TIME, AND COOL FOR 4 HOURS. LET REST IN THE CHEESE SIEVES WITH THE EXTENSION TO ENSURE THEY RELEASE MORE SERUM. REST IN FRIDGE FOR AT LEAST 5 HOURS. EAT FRESH AND NATURAL OR ADD AROMATIC HERBS.
OR SALT AND RIPEN FOR ABOUT 1 TO MAX. 2 WEEKS.

THE CACIOTTA CHEESE WILL BE SUITABLE FOR GRATING.

### Example 14

### Cheese made from Starting Material with Pasty Consistency

### Ingredients:

OKARA (FIBRE), RESIDUAL FROM THE EXTRACTION of any type of vegetable milk, for example PUMPKIN SEED or almond milk
SALT TO TASTE
Optional flavoring ingredients for example, PEPPERCORNS, TRUFFEL, TRUFFEL OIL, SWEET PAPRIKA, GARLIC, OIL AND CHILLI PEPPER

### Process

STEP 1: Make a basic material for fermentation having pasty consistency by REALLY COMBINING THE FIBRE of PUMPKIN SEEDS, ADDING SALT IF NECESSARY, AND OPTIONALLY FLAVORING TO TASTE.
STEP 2: FERMENTATION—Fermentation starts spontaneously. The step preferably lasts up to a maximum of 10 hours.
STEP 3: PUT THE MIXTURE IN A CHEESE SIEVE AND LET IT REST AND DRAIN IN THE FRIDGE FOR AT LEAST 8 TO 10 HOURS.
STEP 4: RIPENING, preferably for about 2 to 3 WEEKS THE MORE IT RIPENS, THE HARDER IT BECOMES, UNTIL IT IS SUITABLE FOR GRATING.

### Example 15

### Processed or Ripended Cheese

### Ingredients:

WHITE ALMOND VEGETABLE YOGURT
WHITE SEASME (SOURCE OF CALCIUM)
CAROB-SEED FLOUR
SALT
WHEY STARTER CULTURE
HIGH-OLEIC SESAME OIL

### Process

STEP 1: Make a starting material having a creamy consistency by blending together YOGURT WITH WHITE SESAME AND SALT.
STEP 2: FERMENTATION OF THE STARTING MATERIAL preferably FOR ABOUT 8 HOURS
STEP 3: POUR THE FERMENTED MIXTURE INTO THE MIXER AND FIRST ADD A LITTLE TAPIOCA AT A TIME, THEN THE SESAME OIL.
STEP 4: PUT EVERYTHING IN A SAUCEPAN AND SET (NOT COMPLETELY). AS SOON AS THE MIXTURE STARTS TO TAKE ON CONSISTENCY, TURN OFF AND LET THE MIXTURE REACH 41° C.

ENERGETICALLY MIX IN THE WHEY STARTER CULTURE; CONTINUE MIXING UNTIL IT IS COMPLETELY ABSORBED.
STEP 5: PUT THE MIXTURE in a CHEESE SIEVE and LET IT DRAIN AT ROOM TEMPERATURE FOR 8 HOURS.
STEP 6: Consumption or ripen, in this case

REMOVE THE CACIOTTA CHEESE FROM THE MOLD AND LET DRY FOR ANOTHER 12 HOURS. Then SALT IN BRINE OR WITH MOIST HANDS AND SALT BY MASSAGING THE CACIOTTA CHEESE PLACED TO REST ON A STERILE GRILL IN THE SPECIFIC RIPENING ROOM WITH TEMPERATURE NOT EXCEEDING 12°

### Example 16

### Cheese for Grating (Piece of Grattigiano (Type of Parmesan))

Appearance: Type of parmesan

### Ingredients:

VEGETABLE YOGURT CHEESE made with any one of the preceding recipes, preferably using DRAINED YOUGHURT, preferably for about 12 HOURS
MACADAMIA
ALMOND
BRAZILIAN NUTS
DRIED CABBAGE
YACON SYRUP
GARLIC
SALT
WHEY STARTER CULTURE

### Process

STEP 1: BLEND TOGETHER ALL THE DRY INGREDIENTS WITH THE GARLIC AND LET REST FOR 1 HOUR.
COMBINE THE YOGURT CHEESE WITH THE DRY INGREDIENTS AND LET REST FOR 1 HOUR.
POUR EVERYTHING INTO THE MIXER AND BLEND TOGETHER UP TO OBTAINING A COMPACT BUT ROUGH MIXTURE to use as starting material for the fermentation having a pasty consistency.
STEP 2: FERMENTATION (correct?)
STEP 3: POUR EVERYTHING INTO A MOLD WHILE PRESSING DOWN ON THE SURFACE AND LETTING SET FOR ABOUT 3 HOURS.
STEP 4: Salting, for example UNIFORMLY DUST SALT USING DRY HANDS
STEP 5: Ripening, FOR ABOUT 24 HOURS THEN TURN THE PIECE OF CHEESE OVER AND DUST AGAIN WITH SALT. LET RIPEN FOR ABOUT 30 TO 40 DAYS at a maximum temperature of 10° C.

The cheese should be checked and turned over every day. To avoid the undesired growth or mold.

The cheese is ready when it is rather hard and dry.

GENERAL EXAMPLE OF SELF-MADE VEGETABLE YOGURT TO BE USED IN THE STARTING MATERIALS:

To date, the Applicant prefers self-making the yogurt to avoid industrial soya-based products. The following process is capable of making vegetable yogurt with any vegetable ingredient.

### Example 17

### Almond Yogurt

### Ingredients:

Thick ALMOND MILK
At least one vegetable probiotic ingredient
Vegetable-based whey starter culture
ALMONDS

### Process:

Thick almond milk in general is intended as an almond milk obtained with a greater quantity of almonds than the ones used to make almond milk not intended for making yogurt. For example, 100 grams of almonds in one litre of water is a normal milk, while milk with 200 grams of almonds for one litre of water is thick.

Blend together the thick almond milk with the almonds to increase the percentage of fats to promote the curd that forms the yogurt. Bring to a temperature of about 40° and then add the at least one vegetable probiotic ingredient. Let the mixture ferment for a period of less than or equal to 10 hours. Keep the temperature constant during fermentation, for example from 24° C. to 40° C. The higher the temperature, the fewer fermentation hours are required. Alternatively, it is possible to make yogurt with the same process using any other type of vegetable milk and/or seeds, for example milk and pumpkin seeds and/or sesame seeds. It is always preferable to avoid soya because it has too many proteins and harmful hormones for one's health.

In general, it is worth noting that the steps of the present invention preferably occur in the order in which they were described and/or claimed.

Where one type of specific milk, yogurt, seed or probiotic is indicated in the recipes, an expert in the field will understand that it can be replaced with any other type of milk, yogurt, seed or probiotic. By way of example, yogurt or almond milk was mentioned as an ingredient; it is intended for the same recipe to be possible for example, with pumpkin seed milk, sesame seed milk, oat milk, etc.

Naturally, the embodiments and variants hereto described and shown are by mere way of example and those skilled in the art may make several modifications and variants in order to meet specific and contingent needs, including for example the combination of said embodiments and variants, all moreover contained within the scope of protection of the present invention defined by the following claims.

1-24. (canceled)

25. A process for making vegetable cheeses without ingredients of animal origin, comprising:
providing a predetermined quantity of starting vegetable material,
thickening the starting vegetable material by spontaneous fermentation or induced fermentation by means of adding at least one fermentation promoter ingredient of vegetable origin.

26. The process according to claim 25, further comprising a hydration step of the starting vegetable material prior to the spontaneous fermentation.

27. The process according to claim 25, wherein the starting vegetable material comprises the following contents, where the parameters are the weight percentage over a total weight:
proteins: from 15% to 30%;
fats: from 45% to 58%;
fibre: from 8% to 15%;
carbohydrates: from 4% to 30%.

28. The process according to claim 25, wherein the starting vegetable material mainly comprises, legumes, dried fruit, oilseeds, or a mix thereof.

29. The process of claim 25, further comprising adding salt to the vegetable starting material prior to spontaneous fermentation.

30. The process of claim 25, wherein spontaneous fermentation occurs by spontaneous fermentation of prebiotics naturally present in the starting vegetable material.

31. The process of claim 25, wherein spontaneous fermentation is triggered by putting the starting vegetable material in an environment with a temperature between 20 and 24° C. and with a humidity between 40 and 60%.

32. The process of claim 25, wherein the fermentation promoter ingredient is a probiotic ingredient cultivated prior to said fermentation of said starting vegetable material, the process comprising the step of inoculating the probiotic ingredient in said starting vegetable material prior to the fermentation thereof in less quantity with respect to the starting material, where the probiotic ingredient is cultivated with at least one of the following processes:
the probiotic ingredient is cultivated by spontaneous fermentation of preferably previously-hydrated vegetable material,
the probiotic ingredient is isolated from the fermented starting material in a preceding iteration of the process, wherein the probiotic ingredient is serum generated during a preceding iteration of the process.

33. The process of claim 32, wherein the probiotic ingredient is at least one selected from a group consisting of: vegetable-based whey starter culture, vegetable probiotic, and vegetable yogurt.

34. The process of claim 25, wherein fermentation occurs in the presence of light.

35. The process of claim 25, wherein fermentation occurs in a closed and airtight environment.

36. The process of claim 25, wherein a fermentation step has a duration comprised between 8 hours and 4 days and occurs in an environment kept at a temperature comprised between 20 and 24° C. with humidity between 40 and 60%, wherein the fermentation step is interrupted after such period.

37. The process of claim 25, wherein fermentation is interrupted if the pH goes outside the range of 4 to 5.

38. The process of claim 25, further comprising making vegetable milk or vegetable yogurt with the starting vegetable material prior to the fermentation, and then using the milk or vegetable yogurt as starting material for the fermentation, where the yogurt is obtained by means of a preceding spontaneous or induced fermentation of the starting vegetable material by means of adding at least one fermentation promoter ingredient of vegetable origin, preferably the milk or the yogurt are added with salt prior to using them for a successive fermentation.

39. The process of claim 25, further comprising stopping the fermentation by changing the temperature.

40. The process of claim 39, wherein after stopping the fermentation, resting a mass agglomerated by fermentation at a temperature below a fermentation temperature, preferably for a sufficient time to increase the consistency thereof.

41. The process of claim 25, wherein the process obtains a processed vegetable cheese using the following steps:
using a starting material to be fermented, of creamy consistency comprising vegetable yogurt as main ingredient, the starting vegetable material also comprises at least one vegetable oil and at least one fermentation promoter ingredient of vegetable origin;
fermenting the starting material up to a gelatinous consistency;
stopping the fermentation by means of heating, up to the melting of the fermented starting vegetable material to create a melted mass; and
processing the melted mass to obtain a desired shape.

42. The process claim 25, wherein the process obtains a spreadable vegetable cheese by means of the following steps:
using a starting vegetable material to be fermented, of creamy consistency comprising pulsed seeds as main ingredient, the starting vegetable material also comprises at least one fermentation promoter ingredient of vegetable origin;
fermenting the starting vegetable material up to a gelatinous, pasty or creamy consistency;
stopping the fermentation by means of lowering the temperature; and
resting at a temperature below the fermentation temperature.

43. The process of claim 25, wherein the process obtains a sliceable vegetable cheese by means of the following steps:
using a starting vegetable material to be fermented, of creamy consistency comprising pulsed seeds as main ingredient, the starting material also comprises at least one fermentation promoter ingredient of vegetable origin;
fermenting the starting vegetable material up to a gelatinous, pasty or solid consistency;
stopping the fermentation by means of heating to a temperature above the fermentation one and below the melting one;
placing the fermented mass in a mold that allows the exit of the excess liquid; and
resting the mass in mold at a temperature below the fermentation temperature.

44. The process of claim 25, wherein the process obtains a hard vegetable cheese by means of the following steps:
using a starting vegetable material to be fermented, of pasty consistency comprising as main ingredient, at least one among the following, or any mixture thereof: okara, pulsed seeds,
fermenting the starting material up to a solid consistency;
stopping the fermentation by means of changing the temperature; and
resting the fermented mass at a temperature below the fermentation temperature.
